(19) United States
(12) Patent Application Publication
(10) Pub. No.: US 2015/0252494 A1
(43) Pub. Date: Sep. 10, 2015

(54) METHOD FOR PRODUCING POLYESTER FIBERS, POLYESTER FIBERS, YARNS AND TEXTILES

(71) Applicant: SHINKONG SYNTHETIC FIBERS CORPORATION, Taipei (TW)

(72) Inventors: YI-JEN TU, Taoyuan City (TW); KUO-CHUNG WU, Taoyuan City (TW); YUAN-CHEN LIAO, Taoyuan City (TW)

(21) Appl. No.: 14/631,478

(22) Filed: Feb. 25, 2015

(30) Foreign Application Priority Data
Mar. 5, 2014 (TW) 103107335

(51) Int. Cl. D01F 8/14; C08L 67/02

(52) U.S. Cl. CPC D01F 8/14; C08L 67/02

(57) ABSTRACT

The present invention provides a method for producing polyester fibers which improves the defects that polyester fibers and the textiles thereof cannot be easily dyed. In such method, fibers could be dyed by using dispersed dyes at ambient pressure and a temperature of 100° C. or less without adding carrying agents, and have good dyeability, high dyeing deepness and excellent color fastness. The textiles thereof have excellent dyeing retention. In the said method for producing fibers which could be easily dyed at low temperature, a composition consisting of 99.9 to 60% by weight of a first polyester component with a glass transition temperature (Tg) of greater than 20° C. to 100° C. and 0.1 to 40% by weight of a second polyester component with a glass transition temperature (Tg) of 20° C. to −50° C. is melted and spun to such polyester fibers.

### TECHNICAL FIELD OF THE INVENTION

The present invention relates to a method for producing polyester fibers, in particular, relates to a method for producing polyester fibers with low-temperature dyeability.

### DESCRIPTION OF THE RELATED ART

It is known that polyesters fibers, such as polyethylene terephthalate (hereinafter referred to PET), have various advantages such as high strength, good dirt-resistance, etc., and have been broadly used in clothes. However, the biggest drawback of the polyesters fibers such as PET is the poor dyeability. When the polyesters fibers such as PET are dyed by using dispersed dyes, a high temperature of greater than 130° C. should be adapted to conduct the dyeing, which not only waste energy but high-pressure equipment must be used to achieve the high temperature conditions, and this would raise the costs of the equipment. In addition, high-pressure dying process generally is a batch process and thus, the dyeing products cannot be produced continuously and the processing costs increase accordingly.

Moreover, as for the dyeing of the polyesters fibers such as PET and blended fabrics such as nature fibers, elastic fibers, etc., the dyeing cannot be conducted at a high temperature and high pressure as the nature fibers, elastic fibers, etc. are not heat-resistant. To improve such defect, carrying agents or swelling agents are usually added to the dyeing process to reduce the dyeing temperature and pressure. However, in the process using carrying agents or swelling agents, the waste water rejected after dyeing would cause environment pollution easily. Therefore, considering environment protection, the carrying agents or swelling agents should be avoided.

As stated above, if dyeing is conducted in a relatively high temperature of 130° C., the polyesters fibers such as PET are not suitable to be dyed with nature fibers, elastic fibers, etc. which are not heat-resistant in the same vat. As a result, the applications of the polyesters fibers such as PET are restricted. To solve such problem, the dyeing temperature may de reduced to for example 100° C. or less, by which the polyester fibers could be dyed with nature fibers, elastic fibers, etc., and the applications of the polyester fibers are increased.

In addition, in order to improve the dyeability of the polyesters fibers such as PET, it has been tried to blend polybutylene terephthalate (PBT) or polytrimethylene terephthalate (PTT) with the polyesters fibers such as PET to produce the fibers. However, under the state of low temperature (100° C. or less), the deep dyeing effects of the fibers are not desired.

### BRIEF SUMMARY OF THE INVENTION

An object of the present invention is to provide a method for producing polyester fibers which is capable of improving the drawback that the polyesters fibers such as PET and the textiles comprising polyesters fibers such as PET could not be dyed easily at a relatively low temperature.

Further, the phrase “dyed/dyeing at a low temperature” means that the fibers could be dyed at a temperature of 100° C. or less.

To solve the above mentioned problem, the method for producing polyester fibers of the present invention is that a composition consisting of 99.9 to 60% by weight of a first polyester component with a glass transition temperature (Tg) of greater than 20° C. to 100° C. and 0.1 to 40% by weight of a second polyester component with a glass transition temperature (Tg) of 20° C. to −50° C. is melted to a intrinsic viscosity of 0.5 to 1.5 dl/g, and then the composition is spun to polyester fibers.

The present invention also provides polyester fibers obtained by the above mentioned method for producing polyester fibers.

In addition, the present invention provides yarns consisting of the said polyester fibers alone or a complex of the said polyester fibers and other fibers.

Further, the present invention provides textiles consisting of the said polyester fibers or the said yarns.

According to the method for producing polyester fibers of the present invention, the produced polyester fibers have excellent low-temperature dyeability, and the applications of the polyester fibers are expanded.

### BRIEF DESCRIPTION OF THE SEVERAL VIEWS OF THE DRAWING

None

### DETAILED DESCRIPTION OF THE INVENTION

In the method for producing polyester fibers of the present invention, a composition consisting of a first polyester component and a second polyester component is used as the polyester raw material for producing polyester fibers.

As the first polyester component of the present invention, those with a glass transition temperature (Tg) of greater than 20° C. to 100° C. are used. Specifically, the first polyester component is selected from the group consisting of polyethylene terephthalate (PET), polyethylene metaphthalate, a copolymer of polyethylene terephthalate/polyethylene metaphthalate, polybutylene terephthalate (PBT), polytrimethylene terephthalate (PTT), cationic dyeable polyester, recycled PET and BioPET.

The amount of the first polyester component is relatively more than the amount of the second polyester component in the composition, preferably is present in an amount of 99.9 to 60% by weight.

As the second polyester component, a component different from the first polyester component is used, especially those with Tg of 20° C. to −50° C. are used. Specifically, the second polyester component is selected from the group consisting of a copolymer of polybutylene adipate/terephthalate (PBAT)(Tg: −30° C.), a copolymer of polybutylene succinate/adipate (PBSA)(Tg: −45° C.), polybutylene succinate (PBS) (Tg: −32° C.), poly 3-hydroxybutyrate (PHB)(Tg: −9° C.) and a copolymer of poly 3-hydroxybutyrate/3-hydroxyvalerate (PHBV)(Tg: 9° C.).

The reason for choosing those with Tg of 20° C. to −50° C. as the second polyester component is that if Tg of the second polyester component is greater than 20° C., the deep dye effect of the produced fibers at 100° C. or less would become insufficient. On the other hand, if Tg of the second polyester component is less than −50° C., the heat resistance of the composition would reduce, and spinning become difficult.

In addition, the ratio of the second polyester component in the composition is preferably 0.1 to 40% by weight. When the amount of the second polyester component is less than 0.1% by weight, the deep dye effect of the produced fibers at 100° C. or less would become insufficient. On the other hand, when the amount of the second polyester component is greater than 40% by weight, the costs increase and is uneconomic, even though the produced fibers are imparted with higher dyeability.

The inventors of the present invention found that when the first polyester component and the second polyester component are blended in the said ratio, and if the intrinsic viscosity is adjusted to 0.5 to 1.5 (dl/g), the spinning raw material would have excellent low-temperature dyeability.

When the polyester fibers of the present invention are produced, the said spinning raw material is heated to a molten state at a spinneret of a spinning machine, and is wound at a spinning rate of 2500 to 3500 m/min (in the case of POY process) or at a spinning rate of 2500 to 3500 m/min (in the case of HOY process); and then false twist fibers having low-temperature dyeability are produced at a winding rate of 300 to 1300 m/min, at a hot plate temperature of 160 to 400° C. and drawing ratio of 1 to 5 (DTY) or produced by air false twist process (ATY).

In addition, in the method for producing polyester fibers of the present invention, the fibers may also be produced by direct spinning process. Specifically, the said spinning raw material is heated at the spinneret of a spinning machine to the molten state, and then the spin drawn is conducted at a spinning rate of 1000 to 6000 m/min, drawing ratio of 1.0 to 10, a drawing temperature of 25 to 200° C. and a setting temperature of 60 to 260° C. to produce the fully drawn yarns (FOY) having low-temperature dyeability.

The polyester fibers produced in according to the above mentioned method for producing polyester fibers of the present invention may be spun into textiles alone or mixed spun with other fibers (e.g. nature fibers) into textiles. Then, the textiles can be dyed at a temperature of 100° C. or less by using dispersed dyes without adding carrying agents, etc. Since the operation is conducted at ambient pressure, the operation is safer and saves energy, and the waste water produced from dyeing is significantly reduced.

The method for producing polyester fibers of the present invention may produce fibers with circle cross section, non-circle cross section or composite cross section.

Moreover, the method for producing polyester fibers of the present invention is suitable for the production of long fibers and short fibers.

During the process of producing polyester fibers of the present invention, other functional additives such as flame retardants, heat insulating agents, anti-ultraviolet agents, anti-statistic agents, fluorescence brighteners, antibacterial agents, matting agents, etc. may further be added, depending on the demands.

### EXAMPLES

### Example 1

A composition consisting of 85% by weight of polyethylene terephthalate and 15% by weight of a copolymer of polybutylene adipate/terephthalate (PBAT) is molten at 285° C. to have an intrinsic viscosity of 0.640 (dl/g). The composition is then wound at a spinning rate of 3000 m/min to produce 120d/72f partially oriented yarns (POY). The partially oriented yarns are further false twist processed at a winding rate of 600 m/min, at a hot plate temperature of 230° C. and drawing ratio of 1.65 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Example 2

A composition consisting of 85% by weight of polyethylene terephthalate and 15% by weight of a copolymer of polybutylene succinate/adipate (PBSA) is molten at 285° C. to have an intrinsic viscosity of 0.629 (dl/g). The composition is then wound at a spinning rate of 3000 m/min to produce 129d/72f partially oriented yarns (POY). The partially oriented yarns are further false twist processed at a winding rate of 600 m/min, at a hot plate temperature of 230° C. and drawing ratio of 1.72 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Example 3

A composition consisting of 85% by weight of polyethylene terephthalate and 15% by weight of a copolymer of polybutylene succinate (PBS) is molten at 280° C. to have an intrinsic viscosity of 0.64 (dl/g). The composition is then wound at a spinning rate of 3000 m/min to produce 124d/72f partially oriented yarns (POY). The partially oriented yarns are further false twist processed at a winding rate of 600 m/min, at a hot plate temperature of 230° C. and drawing ratio of 1.65 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Example 4

A composition consisting of 95% by weight of polyethylene terephthalate and 5% by weight of a copolymer of polybutylene adipate/terephthalate (PBAT) is molten at 285° C. to have an intrinsic viscosity of 0.640 (dl/g). The composition is then wound at a spinning rate of 3000 m/min to produce 120d/72f partially oriented yarns (POY). The partially oriented yarns are further false twist processed at a winding rate of 600 m/min, at a hot plate temperature of 230° C. and drawing ratio of 1.65 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Example 5

A composition consisting of 99% by weight of polyethylene terephthalate and 1% by weight of a copolymer of polybutylene adipate/terephthalate (PBAT) is molten at 288° C. to have an intrinsic viscosity of 0.640 (dl/g). The composition is then wound at a spinning rate of 3000 m/min to produce 120d/72f partially oriented yarns (POY). The partially oriented yarns are further false twist processed at a winding rate of 600 m/min, at a hot plate temperature of 230° C. and drawing ratio of 1.65 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Example 6

A composition consisting of 60% by weight of polyethylene terephthalate and 40% by weight of a copolymer of polybutylene adipate/terephthalate (PBAT) is molten at 280° C. to have an intrinsic viscosity of 0.640 (dl/g). The composition is then wound at a spinning rate of 3000 m/min to produce 120d/72f partially oriented yarns (POY). The partially oriented yarns are further false twist processed at a winding rate of 600 m/min, at a hot plate temperature of 230° C. and drawing ratio of 1.65 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Example 7

A composition consisting of 85% by weight of polyethylene terephthalate and 15% by weight of a copolymer of polybutylene adipate/terephthalate (PBAT) is molten at 285° C. to have an intrinsic viscosity of 0.640 (dl/g). The composition is then wound at a spinning rate of 5000 m/min, a drawing temperature of 80° C., a setting temperature of 125° C. and a drawing ratio of 2.0 to produce 75d/72f a fully drawn yarn (FDY). The obtained fully drawn yarn is knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Example 8

A composition consisting of 85% by weight of polyethylene terephthalate and 15% by weight of a copolymer of polybutylene adipate/terephthalate (PBAT) is molten at 290° C. to have an intrinsic viscosity of 0.92 (dl/g). The composition is then wound at a spinning rate of 3000 m/min to produce 120d/72f partially oriented yarns (POY). The partially oriented yarns are further false twist processed at a winding rate of 600 m/min, at a hot plate temperature of 230° C. and drawing ratio of 1.65 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Examples 9 to 12

The fabric produced according to the production method of Example 1 is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 90° C. (Example 9), to 110° C. (Example 10), to 120° C. (Example 11), and to 130° C. (Example 12) at a rate of 2° C./min to dye the fabrics. The fabrics are then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabrics are removed and determined with K/S and color fastness. The results of Examples 9 to 12 and the result of Example 1 are shown in Table 2.

### Examples 13 to 16

The fabric produced according to the production method of Example 4 is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 90° C. (Example 13), to 110° C. (Example 14), to 120° C. (Example 15), and to 130° C. (Example 16) at a rate of 2° C./min to dye the fabrics. The fabrics are then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabrics are removed and determined with K/S and color fastness. The results of Examples 13 to 16 and the result of Example 4 are shown in Table 2.

### Examples 17 to 18

A composition consisting of 85% by weight of polyethylene terephthalate and 15% by weight of a copolymer of polybutylene adipate/terephthalate (PBAT) is molten at 235° C. to have an intrinsic viscosity of 0.900 (dl/g). The composition is then wound at a spinning rate of 2500 m/min to produce 110d/72f partially oriented yarns (POY). The partially oriented yarns are further false twist processed at a winding rate of 600 m/min, at a hot plate temperature of 200° C. and drawing ratio of 1.5 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. (Example 17) and 130° C. (Example 18) at a rate of 2° C./min to dye the fabrics. The fabrics are then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabrics are removed and determined with K/S and color fastness. The result of Example 17 is shown in Table 1 and Table 2. The result of Example 18 is shown in Table 2.

### Comparative Example 1

Polyethylene terephthalate is molten at 290° C. to have an intrinsic viscosity of 0.640 (dl/g), and then it is wound at a spinning rate of 3000 m/min to produce 120d/72f partially oriented yarns (POY). The partially oriented yarns are further false twist processed at a winding rate of 600 m/min, at a hot plate temperature of 230° C. and drawing ratio of 1.7 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. at a rate of 2° C./min to dye the fabric. The fabric is then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabric is removed and determined with K/S and color fastness. The results are shown in Table 1.

### Comparative Examples 2 to 5

The fabric produced according to the production method of Comparative Example 1 is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 90° C. (Comparative Example 2), to 110° C. (Comparative Example 3), to 120° C. (Comparative Example 4), and to 130° C. (Comparative Example 5) at a rate of 2° C./min to dye the fabrics. The fabrics are then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabrics are removed and determined with K/S and color fastness. The results of Comparative Examples 2 to 5 and the result of Comparative Example 1 are shown in Table 2.

### Comparative Examples 6 to 7

Polybutylene terephthalate is molten at 275° C. to have an intrinsic viscosity of 0.900 (dl/g), and then it is wound at a spinning rate of 2500 m/min to produce 110d/72f partially oriented yarns (POY). The partially oriented yarns are further false twist processed at a winding rate of 600 m/min, at a hot plate temperature of 200° C. and drawing ratio of 1.5 to produce 75d/72f draw textured yarns (DTY). The obtained draw textured yarns are knitted into fabrics by using a knitting machine with 190 pins. The fabric is put into a dye bath comprising dispersed dye (TERASIL® NAVY GRL-C) and water, wherein the weight ratio of the dispersed dye to the fabric is 0.15 and the weight ratio of the water to the fabric is 30. The dye bath is heated from 40° C. to 100° C. (Comparative Example 6) and 130° C. (Comparative Example 7) at a rate of 2° C./min to dye the fabric. The fabrics are then removed from the dye bath and moved to a solution comprising sodium hydroxide 2 g/l and sodium sulfate 3 g/l wherein the weight ratio of the water to the fabric is 30, and the reduction wash is conducted at 80° C. for 20 minutes. Then, the fabrics are removed and determined with K/S and color fastness. The result of Comparative Example 6 is shown in Table 1 and Table 2. The result of Comparative Example 7 is shown in Table 2.

The physical properties of the textiles produced in the examples and comparative examples of the present invention were measured and assessed by the following methods.

1. Intrinsic Viscosity

The intrinsic viscosity is determined by ASTM D2857-87. Specifically, the yarn materials of each Example and each Comparative Example are molten to sample solutions to be determined; and the flow time of the sample solutions with different concentration (0.1%, 0.2%, 0.3%, 0.4% and 0.5%) and a pure solvent in the capillary Ubbelohde viscometer are respectively measured, and the intrinsic viscosity of each sample solution is determined. Then the intrinsic viscosity is plotted versus the concentration, and the viscosity at the concentration of approximate 0 obtained by extrapolation method represents as the intrinsic viscosity.

2. Dyeing Deepness (Referred to K/S Value)

The dyed textiles are measured the reflection index (R) thereof by color analysis instrument (Tokyo Denshoku; TC-1800MK2). The dyeing deepness is calculated by the following formula. The greater the value, the dyeing color is more deep. Namely, the textile is dyed more easily under the same dyeing conditions.

K/S=(1−R)²/(2R)

3. Color Fastness to Washing

The color fastness is measured by ISO 105-C06 2010 AIS method. Specifically, the obtained textile is cut into the size of 4 cm*10 cm, and then is washed in a tank, wherein ten steel beads were put therein, having a volume of 150 ml and at a temperature of 40° C. The textile is removed therefrom and compared the color before and after wash. The evaluation of the color fastness is based on the manner below:

Color fastness 1 to 3: by naked eye observation, the textile after washing is obviously discolored.
Color fastness 4: by naked eye observation, the textile after washing is slightly discolored.
Color fastness 5: by naked eye observation, the textile after washing is not discolored.

TABLE 1

| | The weight | The weight | | Dyeing | |
|---|---|---|---|---|---|
| | ratio of | ratio of | | Deepness | |
| | the first | the second | | K/S (in | |
| | polyester | polyester | | the case of | Color |
| | component | component | Intrinsic | dyeing at | Fast- |
| | ( wt %) | ( wt %) | viscosity | 100° C.) | ness |
| Example 1 | PET/85 wt % | PBAT/15 wt % | 0.640 | 21.12 | 5 |
| Example 2 | PET/85 wt % | PBSA/15 wt % | 0.629 | 22.76 | 5 |
| Example 3 | PET/85 wt % | PBS/15 wt % | 0.640 | 20.12 | 5 |
| Example 4 | PET/95 wt % | PBAT/5 wt % | 0.640 | 18.82 | 5 |
| Example 5 | PET/99 wt % | PBAT/1 wt % | 0.640 | 7.67 | 4 |
| Example 6 | PET/60 wt % | PBAT/40 wt % | 0.640 | 24.11 | 5 |
| Example 7 | PET/85 wt % | PBAT/15 wt % | 0.640 | 21.02 | 5 |
| Example 8 | PET/85 wt % | PBAT/15 wt % | 0.920 | 20.91 | 5 |
| Example 17 | PBT/85 wt % | PBAT/15 wt % | 0.900 | 23.21 | 5 |
| Comparative | PET/100 | — | 0.640 | 3.98 | 4 |
| Example 1 | wt % | | | | |
| Comparative | PBT/100 | — | 0.900 | 4.36 | 4 |
| Example 6 | wt % | | | | |

From the comparison among the above Examples 1 to 8, 17 and Comparative Examples 1 and 6, it is known that the dyeing deepness K/S of the textiles produced by the method for producing polyester fibers according to the present invention are obvious superior than the conventional textiles produced by single polyester fiber, and the color fastness could be maintained to a level the same or better than the conventional textiles.

TABLE 2

| | The weight | The weight | | | |
|---|---|---|---|---|---|
| | ratio of | ratio of | | | |
| | the first | the second | | Dyeing | Dyeing |
| | polyester | polyester | | Temper- | Deep- |
| | component | component | Intrinsic | ature | ness |
| | ( wt %) | ( wt %) | viscosity | (° C.) | K/S |
| Example 9 | PET/85 wt % | PBAT/15 wt % | 0.640 | 90 | 10.82 |
| Example 1 | PET/85 wt % | PBAT/15 wt % | 0.640 | 100 | 21.12 |
| Example 10 | PET/85 wt % | PBAT/15 wt % | 0.640 | 110 | 21.58 |
| Example 11 | PET/85 wt % | PBAT/15 wt % | 0.640 | 120 | 22.23 |
| Example 12 | PET/85 wt % | PBAT/15 wt % | 0.640 | 130 | 22.48 |
| Example 13 | PET/95 wt % | PBAT/5 wt % | 0.640 | 90 | 7.43 |
| Example 4 | PET/95 wt % | PBAT/5 wt % | 0.640 | 100 | 18.82 |
| Example 14 | PET/95 wt % | PBAT/5 wt % | 0.640 | 110 | 20.00 |
| Example 15 | PET/95 wt % | PBAT/5 wt % | 0.640 | 120 | 20.95 |
| Example 16 | PET/95 wt % | PBAT/5 wt % | 0.640 | 130 | 21.11 |
| Example 17 | PBT/85 wt % | PBAT/15 wt % | 0.900 | 100 | 23.21 |
| Example 18 | PBT/85 wt % | PBAT/15 wt % | 0.900 | 130 | 25.33 |
| Comparative | PET/100 wt % | — | 0.640 | 90 | 1.78 |
| Example 2 | | | | | |
| Comparative | PET/100 wt % | — | 0.640 | 100 | 3.98 |
| Example 1 | | | | | |
| Comparative | PET/100 wt % | — | 0.640 | 110 | 9.95 |
| Example 3 | | | | | |
| Comparative | PET/100 wt % | — | 0.640 | 120 | 15.12 |
| Example 4 | | | | | |
| Comparative | PET/100 wt % | — | 0.640 | 130 | 18.00 |
| Example 5 | | | | | |
| Comparative | PBT/100 wt % | — | 0.900 | 100 | 4.36 |
| Example 6 | | | | | |
| Comparative | PBT/100 wt % | — | 0.900 | 130 | 19.98 |
| Example 7 | | | | | |

From the comparison among Examples 1 and 9 to 12, the comparison among Examples 4 and 13 to 16 and the comparison among Examples 17 and 18, it is known that the textiles produced by the method according to the present invention all show good dyeing deepness in a temperature ranging from 90° C. to 130° C. In addition, from the comparison among Example 9, Example 13 and Comparison Example 2, the comparison among Example 1, Example 4 and Comparison Example 1, the comparison among Example 10, Example 14 and Comparison Example 3, the comparison among Example 11, Example 15 and Comparison Example 4, and the comparison between Example 18 and Comparison Example 7, it is known the textiles produced by the method according to the present invention show higher dyeing deepness as compared with conventional textiles. This shows that according to the production method of the present invention, fibers having excellent low-temperature dyeability in a relatively broad scope could be produced.

Notwithstanding the present invention is disclosed by the above-mentioned examples in detail, those examples are not used to limit the present invention. A person in the art can make various alterations or modifications to the invention without departing from the spirit and scope of the present invention, and such alterations and modifications are also included in the scope of the present invention.

What is claimed is:

1. A method for producing polyester fibers, wherein a composition consisting of 99.9 to 60% by weight of a first polyester component with a glass transition temperature (Tg) of greater than 20° C. to 100° C. and 0.1 to 40% by weight of a second polyester component with a glass transition temperature (Tg) of 20° C. to −50° C. is melted to a intrinsic viscosity of 0.5 to 1.5 dl/g, and then the composition is spun to polyester fibers.

2. The method for producing polyester fibers according to claim 1, wherein the first polyester component is selected from the group consisting of polyethylene terephthalate (PET), polyethylene metaphthalate, a copolymer of polyethylene terephthalate/polyethylene metaphthalate, polybutylene terephthalate (PBT), polytrimethylene terephthalate (PTT), cationic dyeable polyester, recycled PET and BioPET.

3. The method for producing polyester fibers according to claim 1, wherein the second polyester component is selected from the group consisting of a copolymer of polybutylene adipate/terephthalate (PBAT), a copolymer of polybutylene succinate/adipate (PBSA), polybutylene succinate (PBS), poly 3-hydroxybutyrate (PHB) and a copolymer of poly 3-hydroxybutyrate/3-hydroxyvalerate (PHBV).

4. The method for producing polyester fibers according to claim 1, wherein a cross section of the polyester fibers is circle cross section, non-circle cross section or composite cross section.

5. The method for producing polyester fibers according to claim 1, wherein the polyester fibers are long fibers or short fibers.

6. A polyester fiber produced by the method for producing polyester fibers according to any one of claims 1 to 5.

7. A yarn consisting of the polyester fiber according to claim 6 or a complex of the said polyester fibers and other fibers.

8. A textile consisting of the polyester fiber according to claim 6 or the yarn according to claim 7.
